(19) United States
(12) Patent Application Publication
(10) Pub. No.: US 2021/0125197 A1
(43) Pub. Date: Apr. 29, 2021

(54) SYSTEMS AND METHODS FOR MANAGING UTILITY RATES AND DEVICE OPTIMIZATION

(71) Applicant: Nonogrid Technologies, PBC, San Francisco, CA (US)

(72) Inventors: Daniel Leon Lopuch, San Francisco, CA (US); Jonathan Andrew McKay, Oakland, CA (US)

(21) Appl. No.: 17/076,314

(22) Filed: Oct. 21, 2020

Related U.S. Application Data
(60) Provisional application No. 62/926,354, filed on Oct. 25, 2019.

(51) Int. Cl. G06Q 30/02; G06Q 50/06

(52) U.S. Cl. CPC G06Q 30/0201; G06Q 50/06; G06Q 30/0202

(57) ABSTRACT

The present disclosure provides methods and systems for managing energy costs. A method for managing energy costs comprises: obtaining input data related to a property and one or more appliances associated with the property; predicting, based on the input data, energy consumption of the property over a time period; determining a set of candidate energy tariffs applicable to the property based on published utility data and the input data; determining energy costs of the property over the time period for each energy tariff; and identifying and outputting one or more energy tariffs in the set of candidate energy tariffs that reduce or minimize energy costs of the property over the time. The method may also include switching to the recommended tariff and adjusting the operation of the appliance(s) to minimize energy costs. The energy consumption of the property may comprise forecasted energy profile of one or more new appliances.

### CROSS-REFERENCE TO RELATED APPLICATION

This application claims the benefit of U.S. Provisional Patent Application No. 62/926,354 filed on Oct. 25, 2019, the content of which is incorporated by reference.

### BACKGROUND

Utilities offer multiple electricity tariffs to their customers. A tariff is a collection of electric rates and other charges that are applied to customers per the specific definitions of the tariff in order to calculate the final utility bill. Consumers and commercial users may want to minimize electricity (or gas and water) consumption, reduce their monthly costs, take advantage of utility rates that vary during the day or week, and otherwise maximize efficiency and device usage while accomplishing their business, household objectives, or environmental objectives (e.g., reducing carbon emissions).

### SUMMARY

The present disclosure provides methods and systems for reducing costs associated with energy usage—including financial and environmental costs—by optimizing electricity tariffs. The systems described herein may automatically switch between particular tariffs without user intervention.

In some embodiments, methods and systems of the present disclosure may be capable of providing an energy consumption profile for an appliance and/or a property. In some cases, the provided methods and systems may dynamically determine a usage schedule or operation schedule for one or more appliances based on the optimized electricity tariff. Methods and systems of the present disclosure may be implemented on or seamlessly integrated into a variety of platforms, including existing energy/utility management systems or utility software, or implemented as a standalone software application.

In one aspect, a method for managing energy costs may comprise: obtaining input data related to a property and one or more appliances on the property; predicting, based on the input data, energy consumption of the property over a time period; determining a set of candidate energy tariffs applicable to the property based at least in part on published utility data and a portion of the input data; determining energy costs of the property over the time period for each energy rate in the set of candidate energy rates; and identifying and outputting one or more energy rates in the set of candidate energy rates that reduce or minimize energy costs of the property over the time. In some embodiments, the portion of the input data comprises a location of the property or types of said one or more appliances. In some embodiments, the target energy cost is a monetary cost or an environment footprint cost. In some embodiments, determining the one or more optimal tariffs comprises generating a target energy cost value for each of the set of candidate tariffs.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 shows an example of Time-of-Use rates.

FIG. 2 schematically shows a platform in which the method and system for providing energy cost analytics and automated rate switching can be implemented.

FIG. 3 schematically illustrates a system for energy cost management, in accordance with some embodiments of the invention.

FIG. 4 shows an example of an energy consumption forecast.

FIG. 5 shows an example of a user interface for receiving input data about an electric appliance usage.

FIG. 6 shows an example of a user interface for receiving input data for determining a set of candidate utility suppliers.

FIG. 7 shows an example of a user interface for receiving input data for determining a subset of candidate utility suppliers.

FIG. 8 shows a computer system that is programmed or otherwise configured to implement methods provided herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The present disclosure provides systems and methods for reducing costs associated with energy usage, including financial and environmental costs. The system and methods described herein can reduce financial and environmental costs of energy usage by optimizing electricity tariffs. The provided systems and methods may dynamically and automatically switch utility tariff (e.g., electricity rate) thereby reducing the utility cost.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

The term “tariff” as used herein, generally refers to a collection of electric rates and other charges that are applied per the specific definitions of the tariff in order to calculate the final utility bill. For example, a tariff may define service charges, calendar dates like holidays, time of use periods, or consumption tiers. General tariffs charge per unit rates based on consumption and may increase (tiers) based on how much the usage is. Different tariffs may be associated with different utility suppliers or energy providers.

The term “electric rate” or “electricity rate” generally refers to how much the utility will charge per unit of electricity consumed (usually defined in terms of kilowatt hours) or per unit of demand (usually defined in kilowatts). Similarly, utility rate generally refers to how much the utility will charge per unit of energy (e.g., water, gas, electricity) consumed or per unit of demand.

Electricity tariffs can be complicated. Typically, an electricity tariff has three main components. First, the energy usage, which is based on actual usage of electricity measured in kilowatt hours (kWh). The second is the peak demand charge. For example, demand is defined as the average rate at which electricity is consumed during a time interval (e.g., 15-minute intervals). Demand can be measured in kilowatts (kW). The maximum actual demand for all intervals in a time interval (i.e., a month) is called the peak demand. Utility distribution companies usually charge their customers in proportion to their peak demand. Finally, there are taxes, surcharges, rebates and incentives that are added/subtracted to the energy bill. In addition, the rates (i.e., the monetary charge, tariff) of electricity may vary, for example, based on the time-of-day, the time-of-week, and the particular season that the energy is consumed, as well as a particular customer's consumption relative to the baseline consumption in the customer's region or class. Some utility companies may charge higher tariffs (or rates) during on-peak demand periods or durations and lower tariffs during off-peak demand periods or durations.

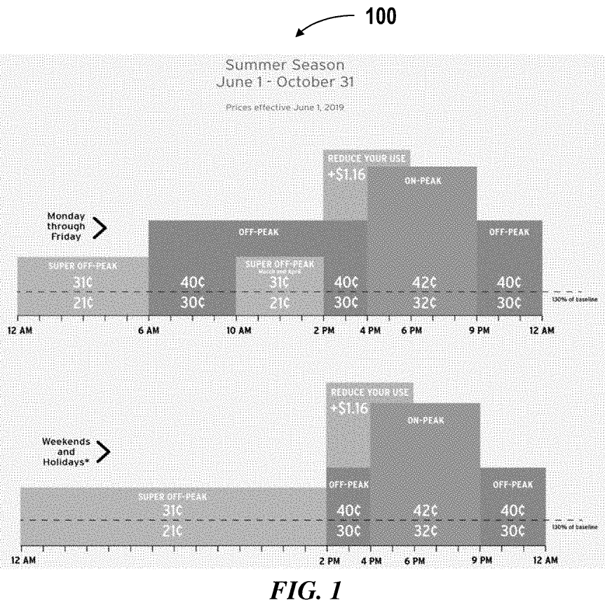

FIG. 1 shows an example of Time-of-Use rates. TOU (Time-of-Use) tariffs are different rates based on the calendar date, time of day, and even time of year or season. Time of day is typically broken down into peak and off-peak hours. During peak hours, electricity rates may be higher. During off-peak hours, electricity rates may be lower. Such a price structure may incentivize customers to use electricity during off-peak hours, thereby distributing electricity consumption more evenly.

A user may be an energy customer or consumer. A user may be an individual, a family, an organization, a house, a building or any entity that buys or pays for energy service. A user may include any private or public concern, such as large companies, small and medium businesses, households, individuals, governing bodies, government agencies, non-governmental organizations, nonprofits, and the like. In some cases, the user may obtain the systems described herein from a third-party that has an interest in reducing energy consumption. For example, a user may obtain the system from a manufacturer of electric vehicles as part of a starter package from the manufacturer. An energy provider, utility supplier or energy supplier may refer to an entity that provides energy service (e.g., energy supply, delivery, utilities, etc) to an energy customer.

The present disclosure provides systems and methods for monitoring and managing users' energy costs to achieve energy-related goals such as monetary demand reduction, carbon reduction, and the like. The energy-related goals may be reducing energy cost. An energy cost may be electricity energy cost which may be measured by the monetary cost (or environmental footprint such as CO₂e (“carbon dioxide equivalent”) intensity.

In some embodiments, machine learning techniques may be used to forecast a property's energy usage.

The provided systems and methods may be capable of reducing energy costs taking into account energy consumption or an energy profile associated with a variety of electrical appliances (e.g., electric vehicle charging, solar production at night, etc). The electrical appliances may include electric loads that can be any electrical devices that consume electric power, such as heat pumps and air conditioners, electric hot water heaters, lights or common lighting circuits, hot tubs, computers, ovens, ranges, refrigerators and kitchen appliances, electric vehicles and various others.

Electric loads can be any kind of electric load capable of being operated in a home, small business, enterprise, or building, such as major appliances (e.g., washers, driers, etc), electronics (e.g., computers, stereos, televisions, game systems, etc), or lighting. The electrical appliances may also include electricity generators that can be any kind of device capable of providing power to an electricity grid, including but not limited to wind turbines or other wind-driven generators, photovoltaic cells or arrays or other devices capable of converting sunlight into electricity, electricity storage devices such as batteries and pumped hydro storage facilities, and the like.

In some cases, machine learning techniques may be utilized for energy consumption forecasting. For example, a trained model may be utilized for generating an energy profile or an energy consumption forecast for an appliance or a property. In some cases, data from a plurality of energy consumption sources associated with a user/account may be processed to generate analytics/forecasting for aggregated energy consumption, and generate energy profile/forecasting for a single appliance and/or a property (e.g., house, building, etc). Utilizing a machine learning algorithm may beneficially allow for an accurate prediction of a load profile associated with a property or an appliance with limited information. For instance, the training datasets may comprise data related to one or more properties/features of an appliance (e.g., electric vehicle) in the neighborhood of the property and such features may be included as part of the input features to be processed by the trained model. This may be useful for predicting the energy consumption of a new appliance (e.g., EV) or the impact of a new appliance on the energy amount of energy consumed.

Data from the plurality of energy consumption sources may comprise, for example, energy consumption data such as measurements from sensor elements, meters, hardware to measure grid operating parameters (e.g., voltage, frequency, phase, current, switch positions, device temperatures), and data from external data sources. The external data sources may include, for example, grid and utility operational systems, meter data management (MDM) systems, customer information systems (CIS), billing systems, utility customer systems, utility enterprise systems, utility energy conservation measures, rebate databases and various others. In some cases, the external data sources may provide non-energy related data. Such external data source may include weather databases, building databases (e.g., Urban Planning Council database), third-party property management systems, and external benchmark databases.

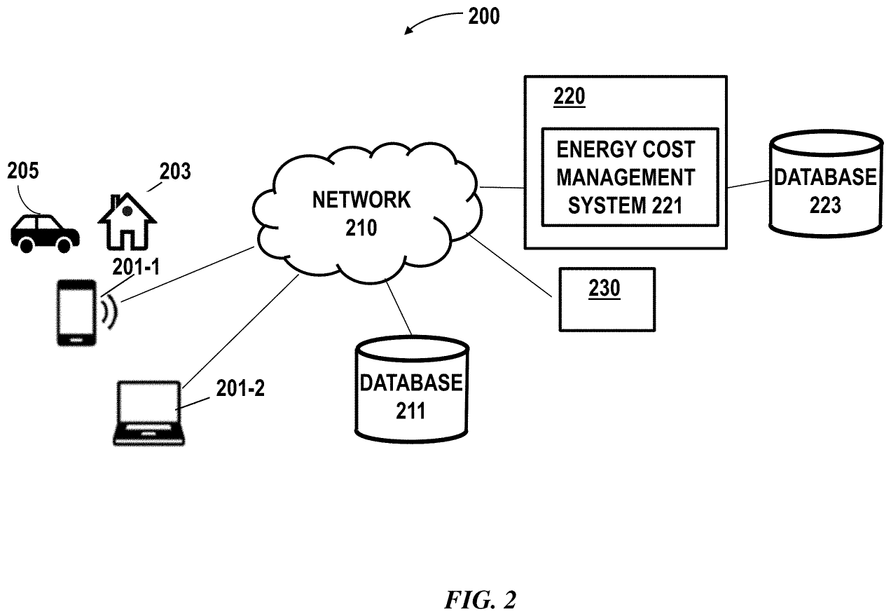

FIG. 2 schematically shows a platform 200 in which the method and system for providing energy cost analytics and automated rate switching can be implemented. A platform 200 may include one or more user devices 201-1, 201-2, a server 220, an energy cost management system 221, one or more third-party systems 230 (e.g., utility system), and a database 211, 223. The platform 200 may comprise sensors, meters, devices for capturing energy consumption data. The energy consumption data may be associated with a plurality of electric appliances 205 such as energy consumed by a variety of electric loads or energy produced by electricity generators. In some cases, the energy consumption profile of a property 203 may be the aggregated energy consumption of the variety of electric appliances 205. The aggregated energy consumption may be used to determine bills or energy costs associated with a user. In some embodiments, the energy cost management system 221 may be capable of reducing the energy cost by switching rates (e.g., utility supplier) in an automated and dynamic fashion. Each of the components 201-1, 201-2, 211, 223, 220, 230 may be operatively connected to one another via a network 210 or any type of communication link that allows transmission of data from one component to another.

In some embodiments, the energy cost management system 221 may be configured to train one or more predictive models for analyzing input data (e.g., data from a plurality of energy consumption sources such as meters/sensors, data transmitted from the user device 201-1, 201-2, the third-party system 230, and/or data sources 211), to generate energy profile for an electric load/appliance and a property, or to perform rate analysis or electric tariff optimization.

The energy cost management system 221 may be configured to perform one or more operations consistent with the disclosed methods and algorithms described herein. In some cases, the energy cost management system 221 may reduce the energy cost by determining an optimal electricity tariff and performing tariff switching according to the optimal electricity tariff in an automated and dynamic fashion. For instance, tariff options from one provider may be automatically switched to a tariff option from another provider determined by the energy cost management system 221. This may beneficially reduce or minimize the energy cost without changing the energy consumption or energy usage habit.

In some embodiments, the energy cost management system 221 may comprise a plurality of components such as a property forecasting component, an appliance forecasting component, an tariff analysis component and a rate switching component. Details about the plurality of functional components are described later herein.

The energy cost management system 221 may be implemented anywhere within the platform 200, and/or outside of the platform 200. In some embodiments, the energy cost management system 221 may be implemented on the server. In other embodiments, a portion of the energy cost management system 221 may be implemented on the user device. Additionally, a portion of the energy cost management system 221 may be implemented on the third-party system. The energy cost management system 221 may comprise machine-executable instructions that are configured to be executed by one or more computers in one or more locations.

In some embodiments, a property 203 may be associated with a plurality of electrical appliances 205. A property may be a residential, industrial, institutional, commercial or any other type. A property 203 may be a home, small business location, enterprise property, a building, or the like. The energy consumption of a property may be the aggregated energy consumption of the plurality of electrical appliances associated with the property.

The electric appliances 205 may comprise electric loads and/or generators. The electrical loads can be any devices that consume electric power, such as heat pumps and air conditioners, lights or common lighting circuits, hot tubs, computers, ovens, ranges, refrigerators and kitchen appliances, electric vehicles and various others.

Electric loads can be any kind of electric load capable of being operated in a home, small business, enterprise, buildings, such as major appliances (e.g., washers, driers, etc), electronics (e.g., computers, stereos, televisions, game systems, etc), or lighting. The electrical appliances may also include energy generators and can be any kind of device capable of providing power to an electricity grid, including but not limited to wind turbines or other wind-driven generators, photovoltaic cells or arrays or other devices capable of converting sunlight into electricity, electricity storage devices such as batteries and pumped hydro storage facilities, and the like.

In some cases, the electric appliances may be connected to energy meters or sensors (e.g., smart meters). The electric appliances may be connected via a data network to the utility, and the utility may be able to take readings at arbitrary time intervals. In some cases, smart meters may be used to enable integration of home automation systems via a local network. For example, small businesses or homes with wireless automation systems for managing lighting, HVAC (heating, ventilation, and air conditioning) systems, and the like are able to integrate these systems with smart meters. In some cases, electric loads may have current sensing and control circuitry capable of communicating with a gateway (for example, “smart thermostats” and “smart appliances”). Alternatively, the electric loads may be connected through wall sockets, surge suppressors, or similar switching devices, which may be able to communicate with a gateway. In some cases, information about the current or power flowing through a load may be passed to a gateway. In other cases, only information about the status of the load, such as whether it is on or off, is provided to a gateway.

The smart meters, sensors or other existing energy meters may be in communication with the third-party system 230 such as a utility system or utility-based data system for billing purpose. The third-party system 230 can be any existing platform that provides energy or utility service. In some cases, the third-party system may be in direct communication with the energy cost management system such that data collected by the third-party system may be accessible to the energy cost management system. In some cases, the third-party system 230 may include, for example, grid and operational systems such as MDM, CIS, and billing systems. The energy cost management system 221 may be in communication with the third-party system 230 to access such electricity consumption data or data useful for energy consumption forecasting.

In some embodiments, a user may be associated with one or more user devices 201-1, 201-2. A user may be an energy consumer such as residential, industrial, institutional, and commercial consumers of energy. A user may be associated with one or more properties 203 and one or more energy billings. In some cases, a user may be allowed to view energy analytics (e.g., energy profile of an electric appliance or a property, electricity tariff analytic result, etc) associated with the user, and perform one or more operations (e.g., provide user input related to the utility or energy profile) via a user interface (UI) provided by the energy cost management system 221.

User devices 201-1, 201-2 may be computing devices configured to perform one or more operations consistent with the disclosed embodiments. Examples of user devices may include, but are not limited to, mobile devices, smartphones/cellphones, tablets, personal digital assistants (PDAs), laptop or notebook computers, desktop computers, media content players, television sets, video gaming station/system, virtual reality systems, augmented reality systems, microphones, or any electronic device capable of analyzing, receiving (e.g., user input data), providing or displaying certain types of data (e.g., energy profile of an electric appliance or a property, electricity tariff analytic result, etc.) to a user. The user device may be a handheld object. The user device may be portable. The user device may be carried by a human user. In some cases, the user device may be located remotely from a human user, and the user can control the user device using wireless and/or wired communications. The user device can be any electronic device with a display.

User device 201-1, 201-2 may include one or more processors that are capable of executing non-transitory computer readable media that may provide instructions for one or more operations consistent with the disclosed embodiments. The user device may include one or more memory storage devices comprising non-transitory computer readable media including code, logic, or instructions for performing the one or more operations. The user device may include software applications (e.g., provided by third-party server 230) that allow the user to view energy billing data, meter readings via the software application, and/or software applications provided by the energy cost management system 221 that allow the user device to communicate with and transfer data between server 220, the energy cost management system 221, and/or database 211.

The user device 201-1, 201-2 may include a communication unit, which may permit the communications with one or more other components in the platform 200. In some instances, the communication unit may include a single communication module, or multiple communication modules. In some instances, the user device may be capable of interacting with one or more components in the platform 200 using a single communication link or multiple different types of communication links.

User device 201-1, 201-2 may include a display. The display may be a screen. The display may or may not be a touchscreen. The display may be a light-emitting diode (LED) screen, OLED screen, liquid crystal display (LCD) screen, plasma screen, or any other type of screen. The display may be configured to show a user interface (UI) or a graphical user interface (GUI) rendered through an application (e.g., via an application programming interface (API) executed on the user device). The GUI may show an energy profile of an electric appliance or a property associated with a user, electricity tariff analytic results associated with a user, or various other analytics result. The GUI may permit a user to input information such as information about the property, an appliance usage profile or energy usage habit, and command for specifying a tariffs qualification accuracy level or sources of data for producing analytics. The user device may also be configured to display webpages and/or websites on the Internet. One or more of the webpages/websites may be hosted by server 220 and/or rendered by the energy cost management system 221.

In some embodiments, users may utilize the user devices to interact with the energy cost management system 221 by way of one or more software applications (i.e., client software) running on and/or accessed by the user devices, wherein the user devices and the energy cost management system 221 may form a client-server relationship. For example, the user devices may run dedicated mobile applications or software applications for viewing energy profiles of electric appliances or a property associated with a user or electricity tariff analytic results associated with a user provided by the energy cost management system 221. The electricity tariff may be optimized by selecting an optimal rate and performing automated rate switching by the energy cost management system 221. In some cases, by optimizing the electricity tariff, the energy cost to a user may be minimized or reduced. The software applications for the utility billing and energy analytics may be different applications.

The energy cost management system 221 may deliver information and content to the user devices related to an energy analytic result (e.g., energy profile of an electric appliance or a property associated with the user, electricity tariff analytic result, etc) and various others, for example, by way of one or more web pages or pages/views of a mobile application. Alternatively or additionally, the energy analytic result provided by the energy cost management system 221 may be integrated into a third-party user interface such as an API integrated to an existing software application such that the energy analytics data may be displayed within a GUI rendered by the third-party system 230. In some cases, the manufacturer of an appliance may provide the energy cost management system to a user. The third-party user interfaces may be hosted by a third-party server. Alternatively or additionally, the energy analytic result and rate/tariffs analysis provided by the energy cost management system 221 may be provided as a standalone software application or can be accessed independent of the third-party utility software application.

In some embodiments, the energy cost management system 221 may be configured to perform rate analysis and dynamic rate switching. In some cases, the energy cost may be reduced or minimized by optimizing the electricity tariffs and switching to the optimal tariffs automatically. In some cases, an optimal rate or optimal tariff may be determined by the energy cost management system 221 such that the rate may be switched to the optimal rate automatically.

In some embodiments, the rate analysis result and the price associated with the optimal tariff may be used for determining an appliance usage schedule or appliance operation schedule. For example, an electric vehicle (EV) may use data about electricity prices for the optimized tariff along with forecasted weather temperature and typical driving habits to determine the charging schedule in order to enable the user to use the vehicle as much as they need while paying less for the electricity. In some cases, the price of the optimal tariff (e.g., time-of-use rate, EV rate, etc) may be used for real-time appliance control. For instance, a connected electric hot water heater may use electricity pricing data and/or the time-of-use rate to determine a heating schedule (e.g., when to heat water) thereby reducing the electricity cost. The pricing information may be used for controlling the operation or usage of one or more appliances or a network of connected appliances (e.g., automated home HVAC system).

In some embodiments, the provided system may generate one or more graphical user interfaces (GUIs). The GUIs may be rendered on a display screen on a user device. A GUI is a type of interface that allows users to interact with electronic devices through graphical icons and visual indicators such as secondary notation, as opposed to text-based interfaces, typed command labels or text navigation. The actions in a GUI are usually performed through direct manipulation of the graphical elements. In addition to computers, GUIs can be found in hand-held devices such as MP3 players, portable media players, gaming devices and smaller household, office and industry equipment. The GUIs may be provided in software, a software application, a mobile application, a web browser, or the like. The GUIs may be displayed on a user device (e.g., desktop computers, laptops or notebook computers, mobile devices (e.g., smart phones, cell phones, personal digital assistants (PDAs), and tablets), and wearable devices (e.g., smartwatches, etc)).

Server 220 may be one or more server computers configured to perform one or more operations consistent with the disclosed embodiments. In one aspect, the server may be implemented as a single computer, through which user device, third-party system 230 are able to communicate with the energy cost management system 221 and database. In some embodiments, the user device or third-party system 230 may communicate with the energy cost management system 221 directly through the network. In some embodiments, the server may embody the functionality of one or more of the energy cost management system. In some embodiments, one or more energy cost management systems may be implemented inside and/or outside of the server. For example, the energy cost management systems may be software and/or hardware components included with the server or remote from the server.

In some embodiments, the user device, third-party system may be directly connected to the server 220 through a separate link (not shown in FIG. 2). In certain embodiments, the server 220 may be configured to operate as a front-end device configured to provide access to the energy cost management system 221 consistent with certain disclosed embodiments. The server may, in some embodiments, host one or more energy cost management systems to process data transmitted from the user device and local energy network, crawled from public websites, retrieved from external databases or the third-party system in order to train a predictive model, perform continual training of a predictive model, deploy the predictive model, and implement the predictive model for generating energy analytics, performing rate analysis and automated rate switching.

The server may also be configured to store, search, retrieve, and/or analyze data and information stored in one or more of the databases. The data and information may include data transmitted from the user device, crawled from public websites, retrieved from external databases or the third-party system, as well as data about a predictive model (e.g., parameters, model architecture, training dataset, performance metrics, threshold, etc), data generated by a predictive model such as the energy profile, electric tariff analytics, energy cost simulation results and the like. While FIG. 2 illustrates the server as a single server, in some embodiments, multiple devices may implement the functionality associated with a server.

A server may include a web server, an enterprise server, or any other type of computer server, and can be computer programmed to accept requests (e.g., HTTP, or other protocols that can initiate data transmission) from a computing device (e.g., user device, local energy control system, etc) and to serve the computing device with requested data. In addition, a server can be a broadcasting facility, such as free-to-air, cable, satellite, and other broadcasting facility, for distributing data. A server may also be a server in a data network (e.g., a cloud computing network).

A server may include known computing components, such as one or more processors, one or more memory devices storing software instructions executed by the processor(s), and data. A server can have one or more processors and at least one memory for storing program instructions. The processor(s) can be a single or multiple microprocessors, field programmable gate arrays (FPGAs), or digital signal processors (DSPs) capable of executing particular sets of instructions. Computer-readable instructions can be stored on a tangible non-transitory computer-readable medium, such as a flexible disk, a hard disk, a CD-ROM (compact disk-read only memory), and MO (magneto-optical), a DVD-ROM (digital versatile disk-read only memory), a DVD RAM (digital versatile disk-random access memory), or a semiconductor memory. Alternatively, the methods can be implemented in hardware components or combinations of hardware and software such as, for example, ASICs, special purpose computers, or general-purpose computers.

Network 210 may be a network that is configured to provide communication between the various components illustrated in FIG. 2. The network may be implemented, in some embodiments, as one or more networks that connect devices and/or components in the network layout for allowing communication between them. For example, user device 201-1, 201-2, third-party system 230, server 220, energy cost management system 221, and database 211, 223 may be in operable communication with one another over network 210. Direct communications may be provided between two or more of the above components. The direct communications may occur without requiring any intermediary device or network. Indirect communications may be provided between two or more of the above components. The indirect communications may occur with aid of one or more intermediary device or network. For instance, indirect communications may utilize a telecommunications network. Indirect communications may be performed with aid of one or more router, communication tower, satellite, or any other intermediary device or network. Examples of types of communications may include, but are not limited to: communications via the Internet, Local Area Networks (LANs), Wide Area Networks (WANs), Bluetooth, Near Field Communication (NFC) technologies, networks based on mobile data protocols such as General Packet Radio Services (GPRS), GSM, Enhanced Data GSM Environment (EDGE), 3G, 4G, 5G or Long Term Evolution (LTE) protocols, Infra-Red (IR) communication technologies, and/or Wi-Fi, and may be wireless, wired, or a combination thereof. In some embodiments, the network may be implemented using cell and/or pager networks, satellite, licensed radio, or a combination of licensed and unlicensed radio. The network may be wireless, wired, or a combination thereof.

User device 201-1, 201-2, third-party system 230, server 220, or energy cost management system 221, may be connected or interconnected to one or more database 211, 223. The databases may be one or more memory devices configured to store data. Additionally, the databases may also, in some embodiments, be implemented as a computer system with a storage device. In one aspect, the databases may be used by components of the network layout to perform one or more operations consistent with the disclosed embodiments. One or more local databases, and cloud databases of the platform may utilize any suitable database techniques. For instance, structured query language (SQL) or “NoSQL” database may be utilized for storing the energy consumption data (e.g., energy forecasting result, energy profile of an electric appliance or property, etc), user profile data, historical data (e.g., meter readings, billings, etc), property related data such as building data (e.g., location, square footage, occupancy, age, building type, building usage such as residential or industrial, number of floors, air conditioned square footage, etc), asset data (e.g., number and type of HVAC assets, number and type of production units (for plants), etc), third-party data such as weather data, and predictive model or algorithms.

Some of the databases may be implemented using various standard data-structures, such as an array, hash, (linked) list, struct, structured text file (e.g., XML), table, JavaScript Object Notation (JSON), NOSQL and/or the like. Such data-structures may be stored in memory and/or in (structured) files. In another alternative, an object-oriented database may be used. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. In some embodiments, the database may include a graph database that uses graph structures for semantic queries with nodes, edges and properties to represent and store data. If the database of the present invention is implemented as a data-structure, the use of the database of the present invention may be integrated into another component such as the component of the present invention. Also, the database may be implemented as a mix of data structures, objects, and relational structures. Databases may be consolidated and/or distributed in variations through standard data processing techniques. Portions of databases, e.g., tables, may be exported and/or imported and thus decentralized and/or integrated.

In some embodiments, the platform 200 may construct the database for fast and efficient data retrieval, query and delivery. For example, the energy cost management system 221 may provide customized algorithms to extract, transform, and load (ETL) the data. In some embodiments, the energy cost management system 221 may construct the databases using proprietary database architecture or data structures to provide an efficient database model that is adapted to large scale databases, is easily scalable, is efficient in query and data retrieval, or has reduced memory requirements in comparison to using other data structures.

In certain embodiments, one or more of the databases may be co-located with the server, may be co-located with one another on the network, or may be located separately from other devices. One of ordinary skill will recognize that the disclosed embodiments are not limited to the configuration and/or arrangement of the database(s).

Although particular computing devices are illustrated and networks described, it is to be appreciated and understood that other computing devices and networks can be utilized without departing from the spirit and scope of the embodiments described herein. In addition, one or more components of the network layout may be interconnected in a variety of ways, and may in some embodiments be directly connected to, co-located with, or remote from one another, as one of ordinary skill will appreciate.

A server 220 may access and execute the energy cost management system 221 to perform one or more processes consistent with the disclosed embodiments. In certain configurations, the energy cost management system 221 may be software stored in memory accessible by a server (e.g., in memory local to the server or remote memory accessible over a communication link, such as the network). Thus, in certain aspects, the energy cost management system(s) may be implemented as one or more computers, as software stored on a memory device accessible by the server, or a combination thereof. For example, one energy cost management system may be a computer executing one or more algorithms for training a predictive model, and another energy cost management system may be software that, when executed by a server, generating energy profiles for energy consumption forecasting using the trained predictive model.

The energy cost management system 221 though is shown to be hosted on the server 220. The energy cost management system 221 may be implemented as a hardware accelerator, software executable by a processor and various others. In some embodiments, the energy cost management system 221 may employ an edge intelligence paradigm that data processing and prediction is performed at the edge or edge gateway (e.g., home automation system, user device, etc). In some cases, a predictive model for generating energy profile may be built, developed and trained on the cloud/server 220 and run on the user device and/or other devices local to the property or appliances (e.g., hardware accelerator) for inference. For example, the predictive model for generating energy analytics and rate analysis may be pre-trained on the cloud and transmitted to the user device or third-party system for implementation.

In some cases, the predictive model may go through continual training as new data and user input are collected. The continual training may be performed on the cloud or on the server 220. In some cases, data may be transmitted to the remote server 220 which are used to update the model for continual training and the updated model (e.g., parameters of the model that are updated) may be downloaded to the physical system (e.g., user device, software application of the utility system, third-party system, etc) for implementation.

The various functions performed by the client terminal and/or the energy cost management system such as data processing, training a predictive model, executing a trained model, continual training a predictive model and the like may be implemented in software, hardware, firmware, embedded hardware, standalone hardware, application specific-hardware, or any combination of these. The energy cost management system and techniques described herein may be realized in digital electronic circuitry, integrated circuitry, specially designed ASICs (application specific integrated circuits), computer hardware, firmware, software, and/or combinations thereof. These systems, devices, and techniques may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, and/or device (such as magnetic discs, optical disks, memory, or Programmable Logic Devices (PLDs)) used to provide machine instructions and/or data to a programmable processor.

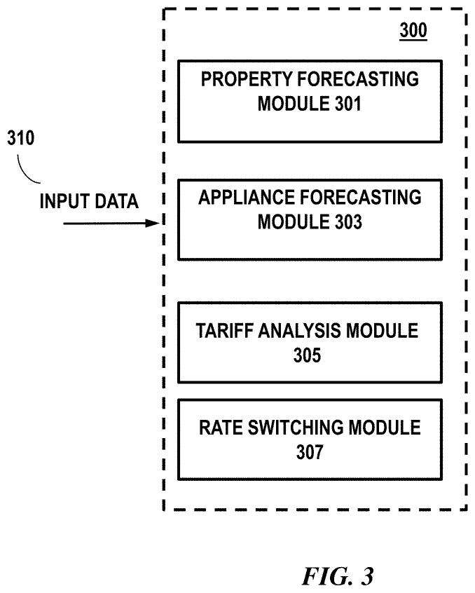

FIG. 3 schematically illustrates a system 300 for energy cost management, in accordance with some embodiments of the invention. In some embodiments, the system 300 may comprise a property forecasting module 301, an appliance forecasting module 303, an tariff analysis module 305 and a rate switching module 307. The system 300 may analyze the input data 310, generate energy profile for an electric load/appliance and a property, perform rate analysis or electric tariff analysis and automate rate switching. The system 300 can be the same as the energy cost management system 221 that is configured to perform one or more operations consistent with the disclosed methods and algorithms described herein.

In some embodiments, the input data 310 may comprise data obtained from a plurality of energy consumption sources such as meters/sensors, data transmitted from the user device, a third-party system and/or data sources. The input data may include, for example, historical data (e.g., meter readings, billings, etc), property related data such as building data (e.g., location, square footage, occupancy, age, building type, building usage such as residential or industrial, number of floors, air conditioned square footage, etc) or asset data (e.g., number and type of HVAC assets, number and type of production units (for plants), etc). The input data may also comprise data useful for forecasting an energy usage of the property or appliance such as weather data (e.g., temperature, humidity, etc) at daily or other time intervals (e.g., hourly intervals), aggregation definitions (hierarchy) (e.g., meters to building, buildings to city block, building's regional identification, etc), appliance usage profile or usage pattern (e.g., electric vehicle driving pattern, hot water usage pattern, etc) and various others.

However, it should be noted the provided methods and systems are not limited to electricity cost management. Systems and methods of the present disclosure may be applied to other types of energy or utilities such as gas and water. In such cases, the input data may include the related energy consumption data (e.g., water consumption, natural gas consumption, etc) that may be processed for generating the energy profile or determining the optimal rate.

The property forecasting module 301 may be configured to estimate energy consumption values for a property. The energy consumption data related to a property may be forecasted and estimated at user-defined time intervals over a selected time period. The estimated energy consumption data related to a property may also be referred to as the energy profile of the property. The time intervals may be a minute interval (e.g., 15 minutes, 30 minutes, or 60 minutes, etc), an hourly interval (e.g., 1 hour, 2 hours, or 3 hours, etc), a daily interval, a weekly interval, a monthly interval, or a yearly interval. The time period may be a week, a month, a season, a year and the like. In some embodiments, the time interval and/or the time period may be user-selectable. For instance, a user may be permitted to input the time interval or the time period for generating an energy consumption forecast result for an associated property.

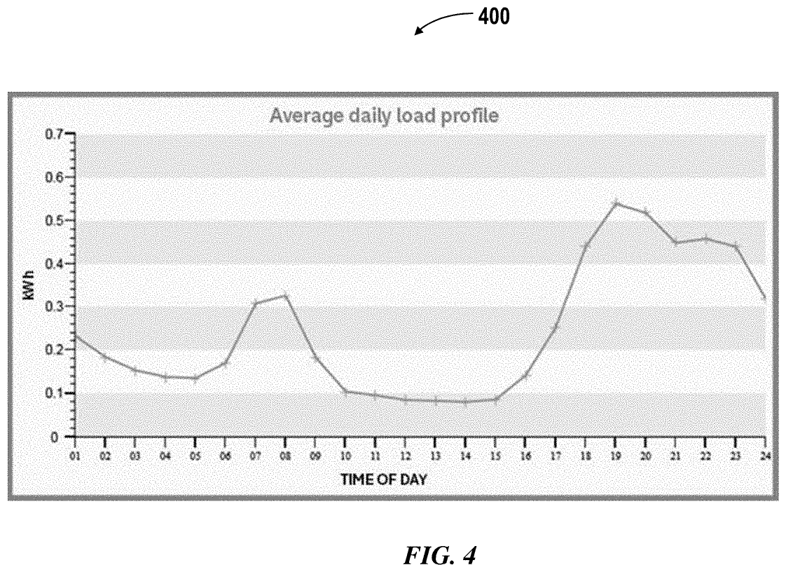

In some embodiments, the energy profile of the property may be electricity consumption that is an aggregated energy consumption data of various electric appliances. FIG. 4 shows an example of an energy consumption forecast 400. As shown in the example, the energy consumption forecast is an average daily load profile of a property. The energy profile may be displayed within a GUI. The GUI may be rendered on a user device. A user may provide user input for generating or viewing the energy profile of a property of the user. For example, the user may specify parameters such as time intervals (e.g., 1 hour) and the time period (e.g., 1 day) via the GUI. The user may provide the parameters (e.g., time interval, time period) for the energy profile in various forms. For example, a user may provide direct input of the parameters or interact with graphical elements such as drop-down list, slider bars, tables, charts, pictorial representations, and the like. A user may interact with the GUI through direct touch on a screen or I/O devices such as handheld controller, mouse, joystick, keyboard, trackball, touchpad, button, verbal commands, gesture-recognition, attitude sensor, thermal sensor, touch-capacitive sensors, or any other device.

The energy profile of the property may be a forecasted energy consumption generated based on partial information. For instance, the input data may comprise information about certain properties/features of an appliance (e.g., electric vehicle) in the neighborhood of the property and such features may be included as part of the input features to be processed by the property forecasting module 301. This may be useful for predicting the energy consumption of a new appliance (e.g., EV) or the impact of a new appliance on the energy cost.

The energy profile of a property may be associated with an electric tariff. The energy profile may be generated using a predictive model. A predictive model may be a trained model or trained machine learning algorithm. The machine learning algorithm may be used to generate an energy profile of a property. The machine learning algorithm can be any type of machine learning network such as: a support vector machine (SVM), a naïve Bayes classification, a linear regression model, a quantile regression model, a logistic regression model, a random forest, a neural network, convolutional neural network CNN, recurrent neural network RNN, a gradient-boosted classifier or repressor, or another supervised or unsupervised machine learning algorithm (e.g., generative adversarial network (GAN), Cycle-GAN, etc).

In some cases, the predictive model may be continually trained and improved using proprietary data or relevant data (e.g., user provided data, new data collected from the third-party data sources, etc) so that the output can be better adapted to the energy consumption pattern, one or more appliances usage pattern, user preference and other real-time factors. In some cases, a predictive model may be pre-trained and implemented on the existing utility system, and the pre-trained model may undergo continual re-training that involves continual tuning of the predictive model or a component of the predictive model (e.g., classifier) to adapt to changes in the implementation environment over time (e.g., changes in the energy consumption data, appliance usage data, model performance, user-specific data, etc). For example, the model may be continually trained and updated when a new appliance is added to the property or an appliance is removed from the property.

The machine learning and predictions module may process at least a portion of the input data 310 and output an energy profile of a property. The input data processed by the property forecasting module may include, for example, historical energy data such as smart meter readings or billing information from the utilities, property related data such as property square footage, property zoning and/or usage (e.g., residential, industrial, etc), property location (e.g., regional location, neighborhood, etc), or appliances of the property. The input datasets may optionally include information from grid and operational systems, such as sensor, SCADA, MDM, CIS, and other types of data identified herein. The input data may comprise data useful for forecasting the energy consumption of the property such as climate data (e.g., weather data). The input datasets may comprise data on one or more appliances having similar properties (e.g., property location) such that energy consumption of one or more new appliances may be forecasted without requesting the historical data of the same appliances.

In some cases, a user may be permitted to select an accuracy level for the forecast. For example, a user may select the accuracy level from (i) a high accuracy level or (ii) a fast prediction with low accuracy. Different accuracy levels may require different input datasets. For instance, upon receiving a user input indicating a high accuracy level, more input data may be required in order to output an accurate forecast result. For instance, the user may be prompted to provide more information about the property or usage profile of one or more appliances and the like via the GUI. Alternatively, if the user input indicates a fast prediction with lower accuracy, less input data may be required for generating the energy consumption forecast.

Referring back to FIG. 3, the appliance forecasting module 303 may be configured to estimate energy consumption values for an appliance. In some cases, the energy profile of an electric appliance may be generated based at least in part on a portion of the input data 310. For example, the portion of the input data may comprise historical appliance usage data and user input data. The historical appliance usage data may be obtained automatically such as retrieved from a third-party database/system. For example, telemetry data about the usage of an electric vehicle (e.g., mileage, driving speed, driving pattern, charging pattern, etc) may be retrieved from the original equipment manufacturer (OEM) system. In some cases, the user input data may be provided via a user interface (UI).

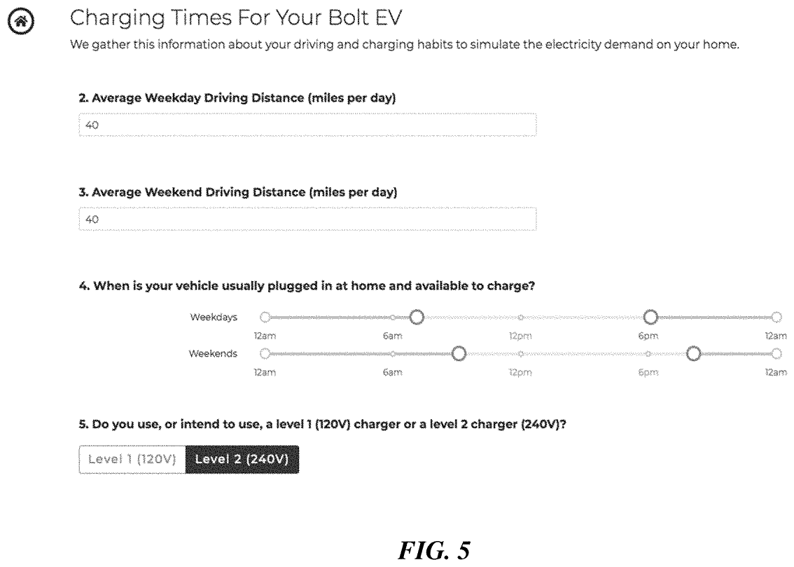

FIG. 5 shows an example of a user interface for receiving input data about an electric appliance usage. The user interface may be a graphical user interface (GUI). The GUI may be rendered on a user device. A user may provide user input related to the usage of an appliance. In the illustrated example, the user may provide information about driving an electric vehicle (e.g., miles per day on the weekdays and weekend) and charging the electric vehicle (e.g., charging schedule, level of charger, etc) via the GUI. The user may provide the input data in various forms. For example, a user may provide direct input or interact with graphical elements such as drop-down list, slider bars, tables, charts, pictorial representations, and the like. A user may interact with the GUI through direct touch on a screen or I/O devices such as handheld controller, mouse, joystick, keyboard, trackball, touchpad, button, verbal commands, gesture-recognition, attitude sensor, thermal sensor, touch-capacitive sensors, or any other device.

The energy profile of a selected electric appliance may be generated using a predictive model. A predictive model may be a trained model or trained machine learning algorithm. The machine learning algorithm may be used to generate an energy profile of an electric appliance. The machine learning algorithm can be any type of machine learning network such as: a support vector machine (SVM), a naïve Bayes classification, a linear regression model, a quantile regression model, a logistic regression model, a random forest, a neural network, convolutional neural network CNN, recurrent neural network RNN, a gradient-boosted classifier or repressor, or another supervised or unsupervised machine learning algorithm (e.g., generative adversarial network (GAN), Cycle-GAN, etc).

In some cases, the predictive model may be continually trained and improved using proprietary data or relevant data (e.g., user provided data, new data collected from the third-party data sources, etc) so that the output can be better adapted to the energy consumption pattern, appliance usage pattern, user preference and other real-time factors. In some cases, a predictive model may be pre-trained and implemented on the existing utility system, and the pre-trained model may undergo continual re-training that involves continual tuning of the predictive model or a component of the predictive model (e.g., classifier) to adapt to changes in the implementation environment over time (e.g., changes in the energy consumption data, appliance usage data, model performance, user-specific data, etc).

Referring back to FIG. 3, the tariff analysis module 305 may be configured to analyze electric tariffs to identify the optimal rate(s) that may optimize or minimize an energy cost. The energy cost may be monetary cost based on factors such as electricity rate, time of usage, energy consumption data, or an environmental cost such as CO₂e (“carbon dioxide equivalent”) intensity or a combination of both.

In some embodiments, a user may be permitted to select a type of energy cost or a target cost. For example, a user may select to minimize the monetary cost, minimize the CO₂e cost or minimize a combination of both. Different target costs may require different input datasets. For instance, upon receiving a user input indicating a monetary cost, tariff pricing data may be required in order to generate an estimated energy cost. Alternatively, if the user input indicates CO₂e cost, input data such as CO2e per kWh may be required for generating the estimated energy cost.

In some embodiments, the tariff analysis module 305 may be configured to perform rate analysis and determine one or more optimal energy tariffs. In some cases, a geographic region may have multiple energy providers, and the optimal tariff may be a tariff offered by a different energy provider than a customer's current energy provider. In some other cases, the geographic region may have only one energy provider, and the optimal tariff may be a different tariff from that provider. In some cases, an optimal energy provider or rate may change dynamically over time such that the rate may be automatically switched to the optimal rate at a given point in time according to a schedule.

In some cases, the one or more optimal energy providers may be determined based on the energy cost analysis result. In some cases, the energy cost may be analyzed, estimated or simulated in order to identify one or more optimal electricity tariffs/rates that optimize or minimize a target cost (e.g., monetary cost, CO2e or both) for a given time period. In some embodiments, the electric tariff may be determined by: (1) determining a set of candidate electricity suppliers and (2) determining one or more optimal electricity suppliers/rates that minimize the target cost.

In some embodiments, the set of candidate electricity suppliers may be determined based on data related to the property (e.g., property location, region, etc) associated with the user, data retrieved from third-party data sources (e.g., government regulations, utility supplier database, etc) and/or user provided data. In some cases, the user input data may be provided via a user interface (UI). In some cases, the set of candidate electricity suppliers may be determined based on applicability criteria on the one or more appliances.

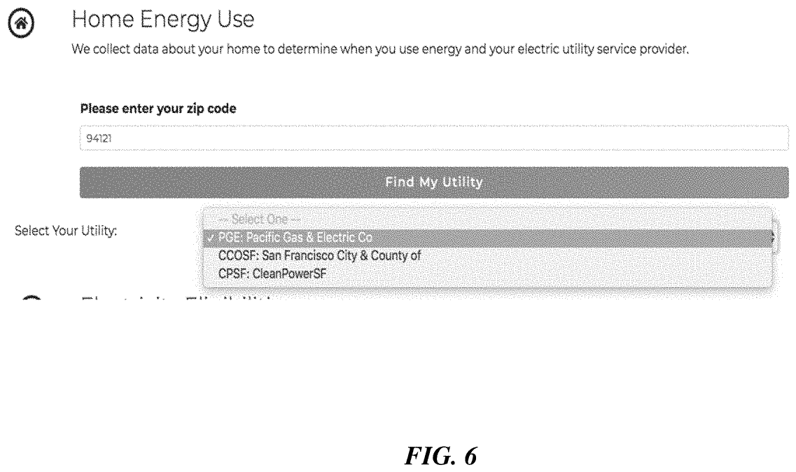

FIG. 6 shows an example of a user interface for receiving input data for determining a set of candidate utility suppliers. The user interface may be a graphical user interface (GUI). The GUI may be rendered on a user device. A user may be prompted to input data for determining a set of candidate utility suppliers. In the illustrated example, the user may input information about zoning/location of the property via the GUI. In some cases, upon receiving the user input data, a list of candidate utility suppliers may be determined. Alternatively or in addition to, the property data (e.g., property location) may be retrieved from the utility company or other data sources.

In some cases, a subset of the set of candidate electricity suppliers may be determined based on further user input data such as user data (e.g., user income, qualification for an electricity tariff, etc) or information about one or more appliances associated with the user. This may beneficially allow for rate analysis or rate switching performed at different accuracy levels. For instance, a user may choose to provide more input data in order to obtain rate analysis with higher accuracy or fewer input data for a faster rate analysis with lower accuracy.

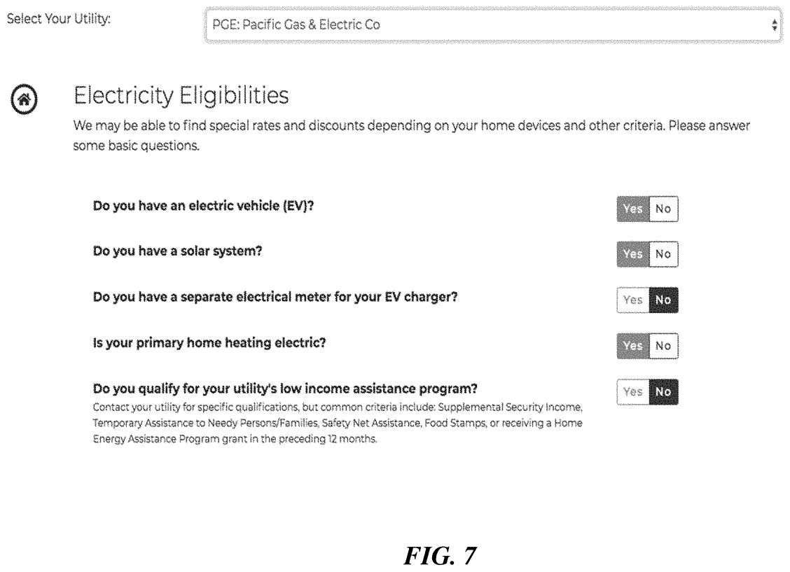

FIG. 7 shows an example of a user interface for receiving input data for determining tariffs available to a user. The user interface may be a graphical user interface (GUI). The GUI may be rendered on a user device. A user may provide user input helpful for identifying qualified and available electricity rates more accurately. In some cases, such user input may also be useful for making adjustments to the pricing of utility rates. In the illustrated example, the user may input information about the eligibility/qualification for special programs (e.g., home income, customer specific program offerings, customer specific prices or incentives, etc), or information about one or more appliances (e.g., EV and availability of meter of the EV, solar system, home heating electric, etc).

The optimal electricity tariffs or rates may be determined based on the estimated energy cost. The energy cost may be simulated over a pre-determined time period (e.g., daily, weekly, monthly, etc) at pre-determined time intervals (e.g., minute, hour, etc). In some cases, the optimal electricity tariffs or rates may be identified from the subset of candidate electricity suppliers.

The optimal electricity tariffs or rates may be ones that minimize the total estimated energy cost over a pre-determined time period. In some cases, the energy cost may be simulated or estimated based on the forecasted energy consumption data and the subset of candidate electricity tariffs. For instance, a consumption vector of the estimated load profile with each entry representing the amount of electricity consumed at each interval (in kWh or kW) may be obtained from the vector containing the cumulative consumption across the property and the appliance(s). Next, a price vector for each candidate tariff where each entry is the price of the tariff at that interval is generated. The units may be, for example, in dollars per kWh or CO2e per kWh depending on the target cost. Next, a total cost vector may be produced by multiplying the consumption vector by the price vector with each entry representing the estimated cost at each interval. Finally, each entry of the total cost vector may be summed up to generate a value that represents the estimated cost for the time period.

The optimal tariffs may be selected as the ones that minimize the estimated cost for a given time period. The optimal tariffs at different points in time over the period (e.g., 1 day, 1 week, 1 month, etc) may be different. In some cases, a rate switching schedule may be generated comprising information about the optimal tariffs at different time points. In such case, the rate may be automatically switched to the optimal rate according to the rate switching schedule. Alternatively, the optimal tariffs over the time period may be the same. The interval in which an optimal tariff is determined may be a fixed interval such as 1 day, 1 week, 1 month, 1 year, etc. In some cases, the optimal tariffs may be determined on demand (e.g., upon a user command). In some cases, the optimal tariffs may be updated dynamically. For instance, the optimal tariffs may be determined upon detecting a new appliance added to the property, an appliance is removed from the property, a change in the appliance usage profile, a change in the energy profile of the property, a change in the candidate tariffs (e.g., availability of tariffs, prince change, etc) or change in any other factors that influences the energy cost.

In some cases, the optimal tariffs may be determined using a trained model. The model may be trained using machine learning techniques. The trained model may process input data (e.g., candidate rates, energy consumption data, property data, weather data, etc) and output an optimal tariff.

Referring back to FIG. 3, the rate switching module 307 may be configured to switch to the optimal rate determined by the tariff analysis module. The rate can be switched automatically in the corresponding time period as described above. In some embodiments, the rate switching module 307 may comprise an application programming interface (API) integrated with the existing utility software or system associated with the user such that rate switching can be performed automatically.

In some cases, the rate switching module 307 may provide a user interface (UI) such as a customer portal for a customer/user to confirm or authorize a rate switching event. In some cases, the UI may allow the user to override the controls during an event or to adjust user-preferred settings (e.g., choose a target cost, confirm or deny an optimal tariff provided by the system, etc). In some cases, the UI may be integrated into an existing software such that customer portal may also provide the customer with customer specific program offerings, messages, prices, or incentives, customer offers, appliance monitoring and diagnostics, bill or tariff information, and the like. In some cases, the UI may display information about the optimal tariff, the amount of cost saved by adopting the tariffs plan, or recommended operation schedule of an appliance generated based on the pricing of the optimal tariff.

In some cases, an appliance operation schedule or appliance usage schedule may be adjusted based at least in part on the optimal tariff. In some cases, upon determining the optimal tariff, information such as price fluctuation over time may be obtained. The associated price (e.g., time-of-use rate, tiered rate, EV rate, feed-in rate, etc) may be used for determining energy consumption profile/schedule of an appliance. For instance, a connected electric hot water heater may use electricity pricing data such as time-of-use rate to determine a heating schedule (e.g., when to heat water) thereby reducing the electricity cost. The rate switching schedule may be used for controlling the operation or usage of one or more appliances or a network of connected appliances.

### Computer Systems

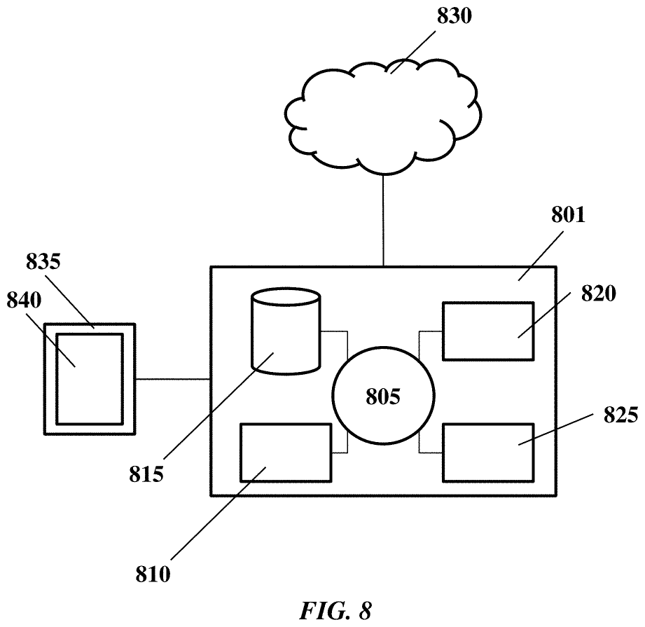

The present disclosure provides computer systems that are programmed to implement methods of the disclosure. FIG. 8 shows a computer system 801 that is programmed or otherwise configured to implement at least a portion of the energy cost management system. The computer system 801 can regulate various aspects of energy cost management system of the present disclosure. The computer system 801 can be an electronic device of a user or a computer system that is remotely located with respect to the electronic device. The electronic device can be a mobile electronic device.

The computer system 801 includes a central processing unit (CPU, also “processor” and “computer processor” herein) 805, which can be a single core or multi core processor, or a plurality of processors for parallel processing. The computer system 801 also includes memory or memory location 810 (e.g., random-access memory, read-only memory, flash memory), electronic storage unit 815 (e.g., hard disk), communication interface 820 (e.g., network adapter) for communicating with one or more other systems, and peripheral devices 825, such as cache, other memory, data storage and/or electronic display adapters. The memory 810, storage unit 815, interface 820 and peripheral devices 825 are in communication with the CPU 805 through a communication bus (solid lines), such as a motherboard. The storage unit 815 can be a data storage unit (or data repository) for storing data. The computer system 801 can be operatively coupled to a computer network (“network”) 830 with the aid of the communication interface 820. The network 830 can be the Internet, an internet and/or extranet, or an intranet and/or extranet that is in communication with the Internet. The network 830 in some cases is a telecommunication and/or data network. The network 830 can include one or more computer servers, which can enable distributed computing, such as cloud computing. The network 830, in some cases with the aid of the computer system 801, can implement a peer-to-peer network, which may enable devices coupled to the computer system 801 to behave as a client or a server.

The CPU 805 can execute a sequence of machine-readable instructions, which can be embodied in a program or software. The instructions may be stored in a memory location, such as the memory 810. The instructions can be directed to the CPU 805, which can subsequently program or otherwise configure the CPU 805 to implement methods of the present disclosure. Examples of operations performed by the CPU 805 can include fetch, decode, execute, and writeback.

The CPU 805 can be part of a circuit, such as an integrated circuit. One or more other components of the system 801 can be included in the circuit. In some cases, the circuit is an application specific integrated circuit (ASIC).

The storage unit 815 can store files, such as drivers, libraries and saved programs. The storage unit 815 can store user data, e.g., user preferences and user programs. The computer system 801 in some cases can include one or more additional data storage units that are external to the computer system 801, such as located on a remote server that is in communication with the computer system 801 through an intranet or the Internet.

The computer system 801 can communicate with one or more remote computer systems through the network 830. For instance, the computer system 801 can communicate with a remote computer system of a user (e.g., customer, energy consumer, etc). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 801 via the network 830.

Methods as described herein can be implemented by way of machine (e.g., computer processor) executable code stored on an electronic storage location of the computer system 801, such as, for example, on the memory 810 or electronic storage unit 815. The machine executable or machine readable code can be provided in the form of software. During use, the code can be executed by the processor 805. In some cases, the code can be retrieved from the storage unit 815 and stored on the memory 810 for ready access by the processor 805. In some situations, the electronic storage unit 815 can be precluded, and machine-executable instructions are stored on memory 810.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 801, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 801 can include or be in communication with an electronic display 835 that comprises a user interface (UI) 840 for providing, for example, the UI as described with respect to FIG. 4-FIG. 7. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 805. The algorithm can, for example, a machine learning algorithm trained model.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A method for managing energy costs comprising:
(a) obtaining input data related to a property and one or more of appliances associated with said property;
(b) predicting, based on said input data, energy consumption of said property over a time period;
(c) determining a set of candidate energy tariffs applicable to said property based at least in part on published utility data and a portion of said input data;
(d) determining energy costs of said property over said time period for each energy tariff in said set of candidate energy tariffs; and
(e) identifying and outputting one or more energy tariffs in said set of candidate energy tariffs that reduce or minimize energy costs of said property over said time.

2. The method of claim 1, wherein said portion of said input data comprises a location of said property or types of said one or more appliances.

3. The method of claim 2, wherein said portion of said input data for determining said set of candidate energy tariffs comprises applicability criteria on said one or more appliances.

4. The method of claim 1, wherein said target energy cost is a monetary cost or an environment footprint cost.

5. The method of claim 1, wherein determining said one or more optimal tariffs comprises generating a target energy cost value for each of said set of candidate tariffs.

6. The method of claim 1, further comprising determining a subset of candidate tariffs from said set of candidate tariffs based on user input data.

7. The method of claim 6, wherein said one or more optimal tariffs are determined from said subset of candidate tariffs.

8. The method of claim 1, wherein said energy consumption of said property is obtained using a trained machine learning algorithm based on said input data.

9. The method of claim 1, wherein an energy consumption of said one or more appliances is obtained using a trained machine learning algorithm based on said input data.

10. The method of claim 1, further comprising displaying said energy consumption of said property or an energy profile of said one or more of said one or more appliances within a graphical user interface (GUI) on an electronic device.

11. The method of claim 1, further comprising adjusting an operation or usage of at least one of said one or more appliances according to an electricity tariff associated with said one or more optimal tariffs.

12. The method of claim 1, further comprising automatically switching to said one or more energy tariffs identified in (d).

13. The method of claim 1, further comprising displaying information on an electronic device to assist a user in switching to said one or more energy tariffs identified in (d).

14. The method of claim 1, further comprising receiving new data related to a new appliance; predicting, based on said new data, energy consumption of said new appliance over said time period; predicting an updated energy consumption of said property if said property had said new appliance using said energy consumption of said new appliance.

15. The method of claim 1, further comprising receiving new data related to a new tariff or a change to at least one of said set of candidate energy tariffs; and determining, based on said new data, an updated energy consumption of said property over said time period.

16. The method of claim 1, wherein said input data comprises data related to historical energy consumption, property square footage, property zoning, property location, type of property, weather, or historical billing.

17. The method of claim 1, wherein said set of candidate tariffs are determined based on a location of said property.
